(19) United States
(12) Patent Application Publication
(10) Pub. No.: US 2025/0375948 A1
(43) Pub. Date: Dec. 11, 2025

(54) BUILDING SHEATHING AND PROCESS FOR MAKING SAME

(71) Applicant: Atlas Roofing Corporation, Meridian, MS (US)

(72) Inventors: Craig Anthony OSBORNE, Delta (CA); Darrell THOMPSON, Meridian, MS (US); Glen LARSON, Delta (CA)

(21) Appl. No.: 19/222,184

(22) Filed: May 29, 2025

Related U.S. Application Data
(60) Provisional application No. 63/656,734, filed on Jun. 6, 2024.

(51) Int. Cl. B32B 3/30; B32B 5/02; B32B 5/18; B32B 15/04; B32B 15/14

(52) U.S. Cl. CPC B32B 3/30; B32B 5/022; B32B 5/18; B32B 15/046; B32B 15/14; B32B 2266/0278; B32B 2307/304; B32B 2607/00

(57) ABSTRACT

A building sheathing comprises a foam core and an embossed facer adhered to a first surface of the foam core. The embossed facer comprises non-planar surface features on an outside surface of the embossed facer. A primary drainage pattern is provided on a first surface of the building sheathing and extends into the embossed facer and the foam core. The primary drainage pattern comprises plural primary drainage channels which define islands on the first surface of the building sheathing.

This application claims the priority and benefit of U.S. Patent application 63/656,734, filed Jun. 6, 2024, entitled “building sheathing AND PROCESS FOR MAKING SAME”, which is incorporated herein by reference.

### TECHNICAL FIELD

This invention pertains to building sheathing and processes for making the same, and particularly to building sheathing having drainage properties.

### BACKGROUND

Many buildings are constructed to have one or more types of sheathing to attach to and cover components of a frame, e.g., to cover components such as studs or roof joists, for example. Some types of sheathing take the form of boards, such as plywood boards, oriented strandboard (OSB), or rigid foam boards. The sheathing is typically overlaid by some type of cladding, such as stucco, siding, brick, etc.

Rigid foam boards are generally tough, lightweight, and resistant to degradation and have many common uses in building and structural materials, such as sheathing in the form of rigid foam board exterior insulation. As part of a wall assembly, rigid foam board provides a continual layer of thermal resistance, often in conjunction with other wall layers that are used to perform other functions such as to control air infiltration, bulk water intrusion, water vapor transmission, and resistance to wind pressure. Accordingly, a need has arisen for rigid foam boards that can perform these other wall functions in addition to thermal resistance.

Some building sheathing takes the form of rigid foam insulation boards which provide resistance to bulk water intrusion and air passage through the wall. These boards or sheathings rely on the natural skin of the foam board or “facers” laminated to the foam board, in conjunction with edge sealing and penetration flashing, to create barrier assemblies. A facer may be any type of covering, e.g., a film or foil, which is secured, e.g., laminated or adhered, to one or both sides of the rigid foam board. The combination of foam board, flexural resistance, and/or facer tension create assemblies that serve as the primary wind barrier of the wall. Rigid foam sheathing may control air, water, thermal resistance, exterior wall water vapor passage, and the transition point of water vapor to liquid.

A non-exhaustive listing of US patents directed to various facers encompassing both fields of gypsum board fiberglass facers and thermosetting polyisocyanurate foam insulation board facers is provided in U.S. Pat. No. 7,867,927 to Bush et al., incorporated by reference herein in its entirety.

Sheathing surfaces such as rigid foam board surfaces may be shaped in various ways to create surface features which, like two layers of felt or wrinkled house wrap, promote hydrostatic pressure reduction, drainage, and ventilation of outer layers of cladding or inner layers of moisture sensitive sheathing such as oriented strand board.

US Patent Publication 2003/0024192 to Spargur, incorporated by reference herein in its entirety, discloses a shape molding operation performed to form a three-dimensional building panel. The operation involves providing a mold having a cavity, the cavity having dimensions essentially identical to a finished three-dimensional building panel suitable for installation. The shape molding operation involves pre-heating at least one of two major internal surfaces of the mold; introducing polystyrene foam beads into the cavity; heating the polystyrene foam beads; and causing the heated polystyrene foam beads to flatten and spread against the pre-heated major internal surface of the mold, thereby forming a sealed water-repellant skin at least on a face of the three-dimensional building panel. In view of the corresponding size of the mold cavity, no cutting action is required on the expanded polystyrene (EPS) foam formed therein, so that a least a building-contacting face of the resultant boards acquires the sealed water-repellant skin that is otherwise lost when forming boards from buns of the prior art. The insulated building panel is preferably formed with said building-contacting surface or face of the panel having a regular pattern of either water drainage grooves or raised protrusions. The protrusions can have various shapes, such as a quadrilateral (e.g., diamond, or rhombus) shape, a circular shape, an elliptical shape, or a triangular shape, for example.

U.S. Pat. No. 10,174,503 to Grant et al., incorporated by reference herein in its entirety, discloses a laminated building sheathing which comprises a rigid foam board and a facer. In production of the sheathing of U.S. Pat. No. 10,174,503, a rigid foam board comprises a drainage pattern formed on a major surface of the foam board before the facer is applied. The drainage pattern comprises a drainage channel. The facer is applied to cover the major surface of the rigid form board and to essentially conform to the drainage pattern. The facer is semi-permanently bonded to the drainage channel but permanently bonded to non-channel planar portions of the major surface.

Some types of sheathing products have a foil facer on one or both sides of a core, e.g., foam board, of the sheathing product. Facers have been provided by Lamtec Corporation which have an embossed (e.g., pre-wrinkled) hard foil with a thickness of 0.00125 inch. The Applicant has previously incorporated such facers with embossed hard foil into an insulation board that is not imprinted with drainage channels. A purpose of previous incorporation of the embossed facer has been to reduce natural reflectivity of the foil and improve the aesthetics of the finished product.

Some types of foam sheathing rely on the stiffness of the facer to help maintain the dimensions of the final product until final curing occurs, such as may be the case with polyisocyanurate foam boards. Some types of foam sheathing use facers that have a facer material composition or production that is not able to stretch or conform to a new shape when dented. The result is that these foam board products tend to resist denting but may experience facer fracture when impacted or pressed. It is often not desirable or possible to replace such facers with stretchy or more elastic facers, which limits the composite foam board product from having a shape pressed into it. Where a shape may be pressed into a portion of a surface of such a composite foam board, the remaining non-pressed portions of the surface impart little to no functionality in terms of imparting drainage or ventilation channels into the foam board.

What is needed, therefore, and a non-limiting example object of the technology disclosed herein, are improved processes for imprinting insulation boards with drainage channels, and the insulation boards produced thereby.

### SUMMARY

In one of its example aspects, the technology disclosed herein concerns a building sheathing. In an example embodiment and mode, the building sheathing comprises a foam core and an embossed facer adhered to a first surface of the foam core. The embossed facer comprises non-planar surface features on an outside surface of the embossed facer. A primary drainage pattern is provided on a first surface of the building sheathing and extends into the embossed facer and the foam core. The primary drainage pattern comprises plural primary drainage channels which define islands on the first surface of the building sheathing.

In another of its example aspects, the technology disclosed herein concerns a building sheathing. In an example embodiment and mode, the building sheathing comprises a foam core and an embossed facer adhered to a first surface of the foam core. The embossed facer comprises an embossed outer layer comprising non-planar surface features on an outside surface of the embossed facer and a scrim layer on a back surface of the embossed outer layer. The scrim layer comprises scrim elements which are at least partially randomly oriented. A primary drainage pattern is provided on a first surface of the building sheathing and extends into the embossed facer and the foam core. The primary drainage pattern comprises plural primary drainage channels which define islands on the first surface of the building sheathing. Secondary drainage channels are provided on at least some of the islands. The scrim elements are configured to contribute to formation of the secondary drainage channels.

In another of its example aspects, the technology disclosed herein concerns a process of making a building sheathing. The process comprises supplying a facer comprising an outside embossed facer layer, the outside embossed facer layer comprising non-planar surface features in a thickness dimension of the facer; using heat and pressure to adhere the facer to the thermosetting foam mixture being conveyed in a machine direction and thereby form a faced thermosetting foam composite; and, before the thermosetting foam composite is cured, embossing a primary drainage pattern on a surface of the thermosetting foam composite using at least in part facer material provided by the non-planar surface features of the outside embossed facer layer.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is sectional side view of a simplified, representative, example laminator assembly suitable for implementing a process for making building sheathing according to an example embodiment.

FIG. 2A is a sectioned end view in a z-y plane depicting a portion along the y axis of a un-embossed facer; FIG. 2B is a sectioned end view in the z-y plane depicting a portion along the y axis of a non-limiting example embossed facer of a type suitable for use with the technology disclosed herein; and FIG. 2C is a sectioned end view in the z-y plane depicting a thickness profile displacement in a thickness dimension between the example embodiment of the un-embossed facer of FIG. 2A and the example embodiment of the embossed facer of FIG. 2B.

FIG. 3A is a top, right perspective view of an example embodiment and mode in which the facer comprises a sheet or layer.

FIG. 3B is a top, right perspective view of an example embodiment and mode in which the facer comprises a trilaminate.

FIG. 3C is a top, right perspective view of an example embodiment and mode in which the facer comprises a bilayer facer which includes a top layer and a scrim layer.

FIG. 4A-FIG. 4E are color perspective views localized portions of four different example facers which may be utilized in conjunction with the technology disclosed herein, in which the facers of FIG. 4A-FIG. 4B utilize essentially linear non-planar surface irregularities 84 and facers of FIG. 4C-FIG. 4E utilize essentially non-linear, e.g., random, non-planar surface irregularities.

FIG. 5 is a top plan diagrammatic view of an enlarged segment of an example sheathing or insulation board illustrating an example primary drainage pattern in the form of intersecting lines in an “X” pattern and secondary drainage pattern shown as multiple intervening wrinkles.

FIG. 6A is a perspective diagrammatic view showing an enlarged section of a portion of an example imprinting grid for an example top imprinting roller.

FIG. 6B shows an enlarged section of a portion of an example grid projection for the imprinting grid of FIG. 6A.

FIG. 6C is a right side view of an example top imprinting roller of FIG. 1.

FIG. 6D is a front view of an end of the example top imprinting roller of FIG. 6C.

FIG. 7 is a flowchart showing basic, representative acts or steps comprising a process of making a sheathing or insulation board of the technology disclosed herein.

### DETAILED DESCRIPTION

In the following description, for purposes of explanation and not limitation, specific details are set forth such as particular architectures, interfaces, techniques, etc. to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail.

All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It must also be noted that as used herein and in the appended claims, the singular forms “a”, “an”, and “the” include plural reference unless the context clearly dictates otherwise. Thus, for example, reference to a “board” is a reference to one or more boards and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. Nothing herein is to be construed as an admission that the invention is not entitled to antedate such disclosure by virtue of prior invention.

The “foam board”, also known as “sheathing” and/or “insulation board”, of example embodiments and modes described herein and/or encompassed hereby may generally include foam boards manufactured using expanded polystyrene (EPS), extruded polystyrene (XPS), polyisocyanurate (PIR), phenolic foam, or other foam boards.

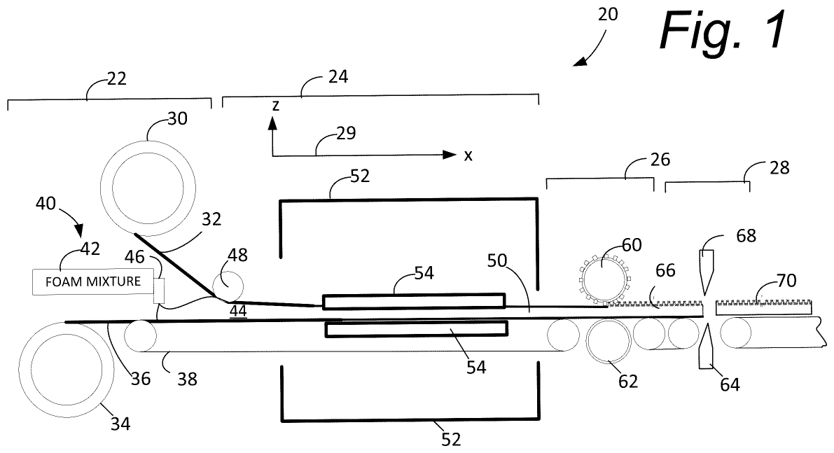

In one of its example aspects the technology disclosed herein concerns a process of making a building sheathing such as an insulation board, and particularly a laminated insulation board. FIG. 1 shows a simplified, representative configuration of an example laminator assembly 20 of a type that may be employed in producing insulation boards of the technology disclosed herein. The laminator assembly 20 of FIG. 1 comprises a material supply section 22; a lamination section 24; an imprinting section 26; and a board cutting section 28. The laminator assembly 20 has a machine direction 29, depicted by arrow 29, also known as the “x” direction or “x axis” in FIG. 1. The machine direction 29 is shown from left to right in the plane of the sheet of FIG. 1 of the serial arrangement of material supply section 22, lamination section 24, imprinting section 26, and board cutting section 28. The width of laminator assembly 20 is understood to be in the y axis or direction, which is perpendicular to the plane of the sheet of FIG. 1; the z axis is orthogonal to both the x axis and the y axis and thus appears as the direction from bottom to top in the plane of the sheet of FIG. 1.

The material supply section 22 comprises top facer supply roller 30, which feeds a web of a top facer 32 to the lamination section 24, and a bottom facer supply roller 34, which feeds a web of a bottom facer 36 to the lamination section 24, and particularly onto bottom facer conveyor 38. As explained herein, at least top facer 32 is an “embossed” facer. The bottom facer 36 may optionally also be an embossed facer. The material supply section 22 further comprises foam mixture discharge station 40. The foam mixture manifold(s) 42 discharge a foam mixture or foam slurry 44 through foam discharge nozzle(s) 46. The top facer supply roller 30, bottom facer supply roller 34, and mixture discharge station 40 extend essentially substantially across the entire width of laminator assembly 20, e.g., essentially substantially across the y axis of the laminator assembly 20. As used herein, the surface of top facer 32, which lies in the x-y plane and which is oriented upward in the z direction sense in FIG. 1, is referred to as the “outside surface” of top facer 32, whereas the opposite surface is referred to as the “inside surface” of top facer 32. The surface of bottom facer 36 in the x-y plane which is oriented downward in the z direction sense in FIG. 1 is referred to as the “outside surface” of bottom facer 36, whereas the opposite surface is referred to as the “inside surface” of bottom facer 36.

The mixture discharge station 40 may comprise plural sets of plural foam mixture manifold(s) 42 to and through which plural foam mixture constituents may be supplied and in which the plural foam mixture constituents may be combined before being discharge through foam discharge nozzle(s) 46, to form the foam mixture 44. The foam mixture 44 is gravity feed onto the web of bottom facer 36, e.g., onto the inside surface of bottom facer 36, which in turn is subsequently carried by bottom facer conveyor 38 into lamination section 24. As the foam mixture components react on the inside surface of the bottom facer 36, internal pressure in the foam mixture causes the foam mixture to rise or expand in the z direction. Side guards or side rails along the laminator assembly 20 prevent the foam mixture 44 from expanding in the y direction. The expanding foam mixture 44, thusly applied to inside surface of bottom facer 36, is then overlaid by an inside or back surface of the top facer 32 which is fed to pass under nip roller 48. Passage under nip roller 48 begins to constrain the expansion of the foam mixture 44, thereby enhancing the internal pressure. The top facer 32 and the bottom facer 36 with the foam mixture 44 constrained therebetween is then fed into lamination section 24, in which the foam mixture 44 essentially becomes the core or center layer of the faced thermosetting foam composite 50 and of a resultant insulation board 70.

For the example, non-limiting embodiments in which the insulation boards are polyisocyanurate boards, the person of ordinary skill in the art understands how to make one or more different types of thermosetting foam mixtures to produce a polyisocyanurate thermosetting foam, and thus how to configure the foam mixture manifold(s) 42 and foam discharge nozzle(s) 46. For example, the person of ordinary skill understands that, in a non-limiting and non-exhaustive example, a two component mixture comprised of a polyisocyanate (A component) and a polyol blend (B component) may be discharged through foam discharge nozzle(s) 46 and thereby used to produce a polyisocyanurate thermosetting foam. See, for example, U.S. Pat. No. 4,459,334 to Blanpied et al., U.S. Pat. No. 5,102,728 to Gay, U.S. Pat. No. 5,001,005 to Blanpied, U.S. Pat. No. 5,294,647 to Blanpied, U.S. Pat. No. 5,847,018 to Blanpied et al, U.S. Pat. No. 5,866,626 to Blanpied et al, and U.S. Pat. No. 6,866,923 to Thornsberry et al, as examples of foam forming mixtures and other aspects of polyisocyanurate technology, all of which are incorporated by reference herein in their entirety. The technology described herein may also be utilized with mixtures other than polyisocyanurate, such as a mixture comprising of a phenol formaldehyde resin, a catalyst (preferably acidic), and a blowing agent (which can be hydrocarbon or hydrofluoroolefin or combination of the two) which may be discharged through a foam discharge nozzle(s) and thereby used to produce a phenolic thermosetting foam.

In lamination section 24, a faced thermosetting foam composite 50 is formed comprising the top facer 32 having an inside surface which overlays the foam mixture 44 deposited on the inside surface of bottom facer 36. In lamination section 24, the faced thermosetting foam composite 50 is formed as the foam mixture 44 undergoes or experiences heat and pressure as the foam mixture 44 is being conveyed in the machine direction 29. The lamination section 24 comprises a lamination section shroud 52 which at least partially encloses the faced thermosetting foam composite 50 as it is carried through lamination section 24. One or more platens 54 are provided within the lamination section shroud 52 and serve to apply heat and pressure to adhere the inside surface of the top facer 32 and the inside surface of the bottom facer 36 to the thermosetting foam slurry or mixture 44 being conveyed in the machine direction 29. The platens 54 are preferably heated to provide the requisite heat. The pressure experienced by the foam mixture 44 in the lamination section 24 results from the internal pressure caused by the expanding foam mixture components as they react upon combination of foam mixture components, i.e., the expanding volume of the foam mixture 44, and also the restraining force applied by the stationary platens 54 to the expanding foam mixture 44. As a result of the application of heat and pressure, the faced thermosetting foam composite 50 is formed with top facer 32 and bottom facer 36 on opposite major surfaces thereof. The portion of faced thermosetting foam composite 50 that formed the foam mixture 44 is the core of the faced thermosetting foam composite 50 and the eventual insulation board 70. FIG. 1 shows the platens 54 situated above and below the conveyed faced thermosetting foam composite 50. In other example implementations, heat and pressure need not be applied through the same structure, e.g., heat may be generated by other means provided within or proximate lamination section 24. Moreover, structures other than platens 54 may be employed to impart one or more heat and pressure.

The extent of lamination section 24 in the machine direction 29 may vary depending on various parameters including the size of the facility which hosts the laminator assembly 20 and a production rate of operating the laminator assembly 20 or line speed of 20. The foam mixture 44 is laid down or fed onto the laminator assembly 20 at a certain application rate or flow rate which is assessed in pounds per minute, and which results in a certain production line speed which is also dependent upon the thickness and volume of the foam mixture 44 being laid down. The length of lamination section 24 may range between 60 feet and 100 feet, and other lengths are also possible. The production rate or line speed of laminator assembly 20 may range between 50 feet per minute and 150 feet per minute, by way of non-limiting examples.

The imprinting section 26 comprises top imprinting roller 60 and bottom roller 62. In a non-limiting example embodiment, top imprinting roller 60 and bottom roller 62 of imprinting section 26 are both situated approximately 15 feet downstream of the lamination section 24 in the machine direction 29. When passing between top imprinting roller 60 and bottom roller 62 the faced thermosetting foam composite 50 is still moldable and is still considered “green”, e.g., is not fully cured. The top imprinting roller 60 comprises an imprinting pattern on its circumference, as herein described, which is essentially imparted to the thermosetting foam composite when the foam mixture 44 has not completed trimerization and can be deformed and yet maintain its deformity. The circumference of bottom roller 62 is preferably smooth, although bottom roller 62 can also optionally bear an imprinting pattern. Before the thermosetting foam composite 50 is cured, in imprinting section 26 a primary drainage pattern 66 is imprinted on a front surface of the thermosetting foam composite 50. The primary drainage pattern 66 results, at least in part, from the imprinting pattern on the circumference of top imprinting roller 60.

As described herein, imprinting of the primary drainage pattern 66 is facilitated, at least in part, by displaced facer material provided by the embossed facer of the top facer 32. As explained further below, the imprinting of the primary drainage pattern 66 may be facilitated by displaced facer material provided by non-planar surface features of the surface of an embossed facer comprising the top facer 32. Those non-planar surface features exist at least on the outside surface of the embossed facer comprising the top facer 32 as supplied by top facer supply roller 30. That is, the non-planar surface features exist at least on the outside surface of the embossed facer before the top facer 32 is fed into laminator assembly 20. Various embodiments of top facer 32 comprising already an embossed facer are hereinafter described. “Already embossed” means that the facer has been embossed to create a non-planar surface prior to introduction into laminator assembly 20.

After emerging from the imprinting section 26, the faced thermosetting foam composite 50 travels further in the machine direction 29 and is thereby cooled and cured. After curing, the faced thermosetting foam composite 50 enters the board cutting section 28. The board cutting section 28 comprises cutting mechanism such as blades or cross-cut saws 68, for example. The cross-cut saws 68 cut the faced thermosetting foam composite 50 into board-length segments, e.g., into the finished insulation board 70 which has the primary drainage pattern 66 imprinted thereon. The insulation board 70 is then carried by one or more conveyors to a post-processing station, such as a packing or loading station.

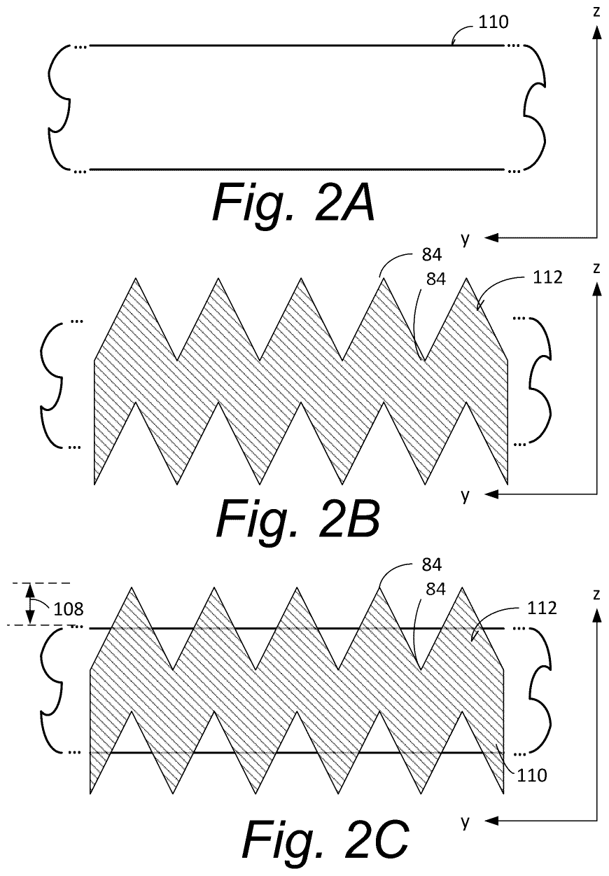

As mentioned previously, at least top facer 32, and optionally bottom facer 36, is an “embossed” facer. With reference to a facer such as top facer 32 prior to introduction into laminator assembly 20, “embossed” means that the facer is not completely planar, but has non-planar surface features or non-planar surface irregularities. Due to the non-planar surface features or non-planar surface irregularities: (1) at least either the contour of the outer surface of the facer varies in the z direction or thickness direction of the facer and/or (2) the thickness of the facer varies in the z direction or thickness direction of the facer. The non-planar surface features or non-planar surface irregularities of the facer may hereinafter be referred to as “wrinkles”, with all three descriptors being interchangeable. The “wrinkles”, e.g., the non-planar surface features or non-planar surface irregularities, are illustrated in FIG. 2B as non-planar surface features 84 as discussed further below. The non-planar surface features 84 may appear as peaks or valleys relative to the surface of a non-embossed facer.

The non-planar surface features or non-planar surface irregularities of the facer are imparted to the facer by a pre-arranged operation, e.g., a mechanical operation, and thus are not incidental or accidental. Nor are the non-planar surface features or non-planar surface irregularities a result of un-intended disruptions in the facer contour or thickness, e.g., the non-planar surface features 84 are not mere imperfections. For example, the non-planar surface features or non-planar surface irregularities may be formed as a part of a programmed operation by a mechanical device such as an embossing roller or other surface feature applicator which has come into contact with the previously un-embossed facer before the top facer 32 is introduced into laminator assembly 20. A circumference of the embossing roller for the facer may have embossing structure that imparts the wrinkles to the embossed facer for a revolution of the embossing roller. The non-planar surface features or non-planar surface irregularities 84 (see FIG. 2B) preferably vary in the z direction or thickness direction of the facer in a region or zone extending in the x-y plane of the facer. The non-planar surface features or non-planar surface irregularities 84 may comprise localized peaks or valleys in the region or zone on the surface of the facer. The extent of the zone or region in the x-y plane may correspond to the circumference of the embossing roller that comes into contact with the facer. A pattern of the non-planar surface features or non-planar surface irregularities for the zone is imparted in the zone as a result of corresponding features on the embossing roller during a revolution of the facer embossing roller. The pattern is repeated during successive revolutions of the facer embossing roller, so that the pattern is repeated in successive zones. Therefore, the non-planar surface features or non-planar surface irregularities may also be referred to as patterned or replicated or repeatable features or irregularities.

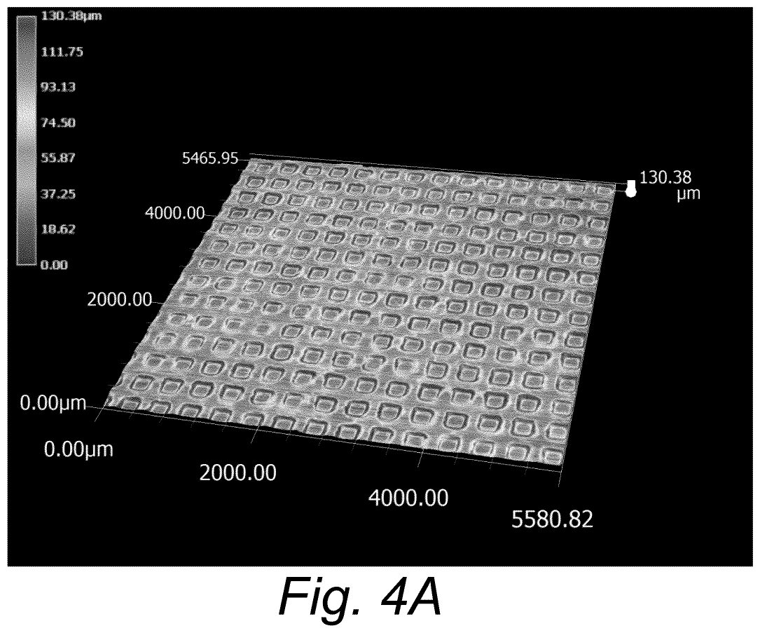

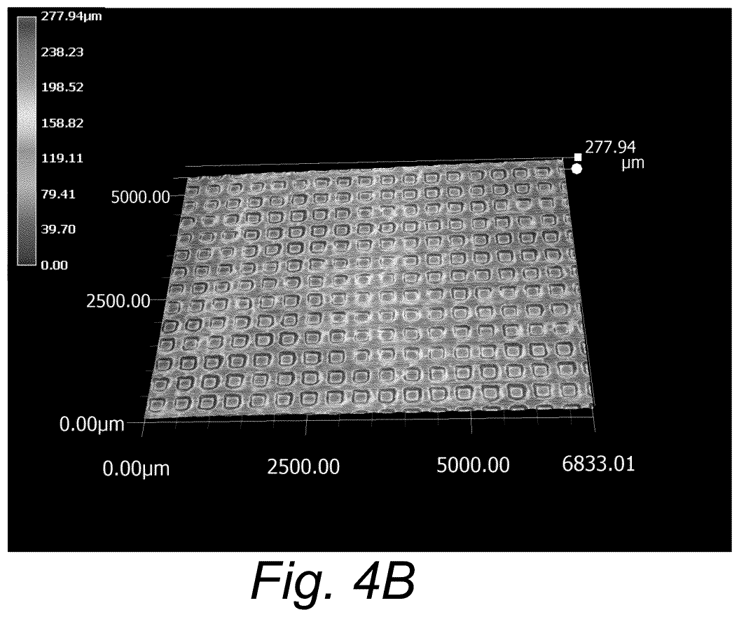

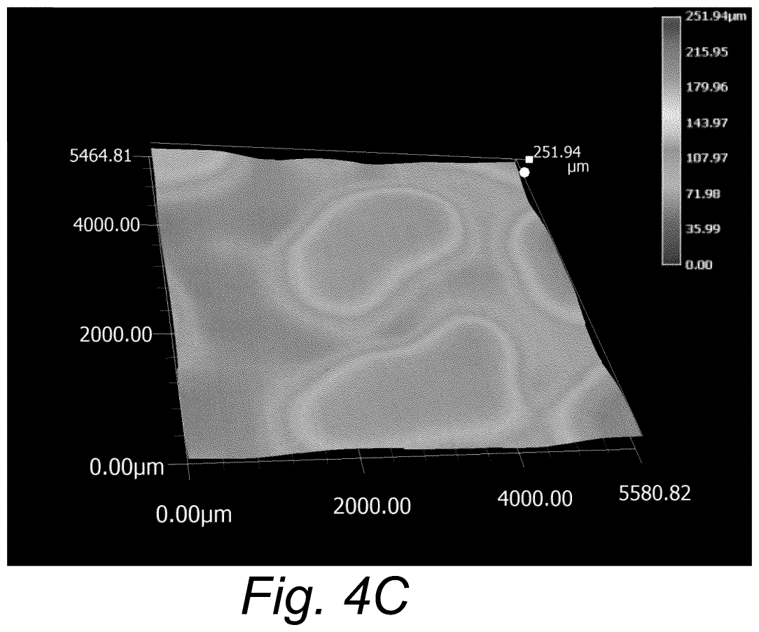

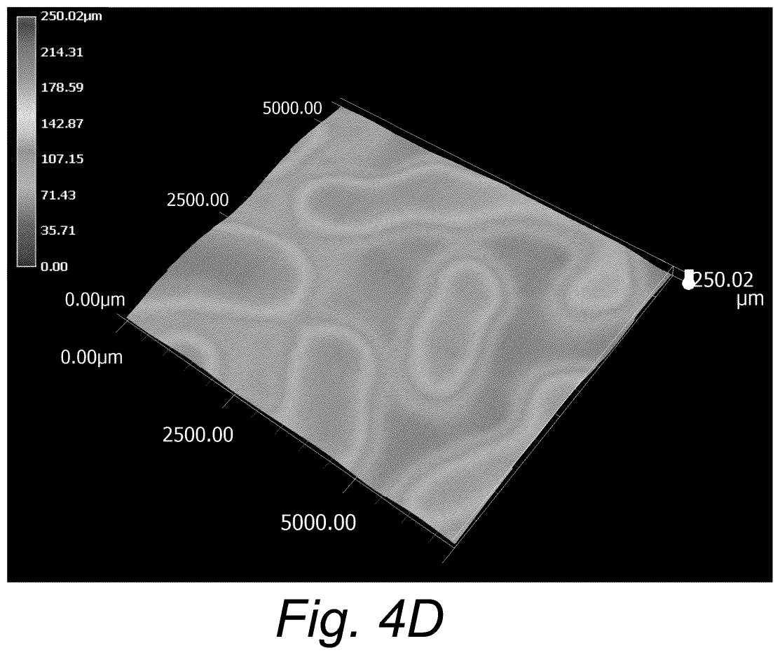

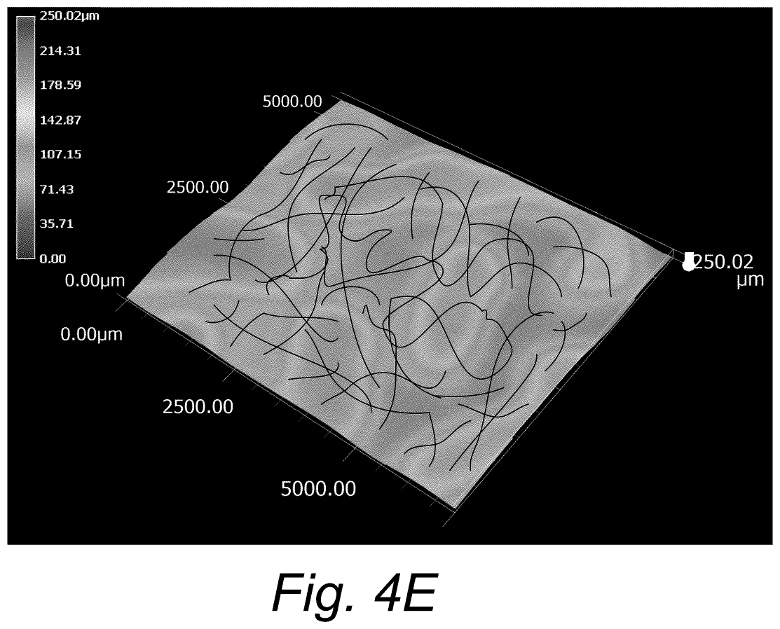

As mentioned above, the non-planar surface irregularities 84 of the facer may comprise localized peaks or valleys in the region or zone on the surface of the facer. In a non-limiting example embodiment and mode, the non-planar surface irregularities 84, e.g., the peaks and valleys, need not align as linear patterns of continuous higher or lower non-planar regions. For example, the valleys or depressed areas can meander as would a stream and may optionally curve to touch each other as would appear to be a pond. Similarly, the peaks can align as would a ridge or raised area and may optionally curve to touch each other as would appear to be a hill, in a manner represented by way of example in one or more of FIG. 4C-FIG. 4E. Moreover, the valleys or depressions do not necessarily continue entirely across or the surface of the facer but may terminate at an ascending topological feature. Similarly, the peaks or elevated features do not necessarily continue entirely across the surface of the facer but may terminate at a valley or descending topological feature. Thus, FIG. 4C-FIG. 4E depict a portion of an example embossed facer of a type suitable for use with the technology disclosed herein in which non-planar surface irregularities of the facer may be provided as at least partially non-linear patterns of continuous higher or lower non-planar regions.

In an example embodiment and mode, an embossed facer such as top facer 32 results from embossing of a previously un-embossed facer. As used herein, the term “facer” is generic and not limited to any particular material(s) which may comprise the facer. In some example embodiments and modes, the facer may comprise or be a foil, e.g., a foil material. The terms “facer” and “foil” may be used interchangeably herein, and in such instance reference to a “foil” should understood to be a reference to a generic facer.

FIG. 2A shows a cross section of a portion of an un-embossed facer 110. In contrast, FIG. 2B shows a cross section of a portion of a non-limiting example embodiment and mode of an embossed facer 112 of a type suitable for use with the technology disclosed herein. FIG. 2C depicts a thickness profile displacement 108 in a thickness or z dimension between a portion of the un-embossed facer of FIG. 2A and a portion of the example embossed facer of a type of FIG. 2B. As such, FIG. 2C contrasts a section of previously un-embossed facer 110 and a section of an example embossed facer 112. FIG. 2C thus depicts an example thickness or profile difference 108 in a thickness dimension, e.g., the z dimension of FIG. 1, between x and y coordinate locations of a previously un-embossed facer 110 and corresponding x and y coordinate locations of features, herein also known as non-planar surface irregularities, of an example embossed facer 112 of a type suitable for use with the technology disclosed herein. In other words, the example thickness or profile difference 108 in the thickness dimension is the distance in the z dimension between a surface of the un-embossed facer 110 at a particular x and y coordinate position and a peak or valley of the embossed facer 112 at the same particular x and y coordinate position. It should be understood that the depictions of FIG. 2A, FIG. 2B, and FIG. 2C are of only a portion of the respective facers along the y dimension, as shown, e.g., by the broken lines at each end of the respective facers.

FIG. 2A, FIG. 2B, and FIG. 2C thus serve to illustrate the example thickness or profile difference 108, which is also representative of a degree of additional or displaced facer material. In the non-limiting example embodiments and modes of Fig. FIG. 2B and FIG. 2C, the non-planar surface irregularities 84 are, for simplicity of illustration, shown to be linear, e.g., to extend in a plane perpendicular to a plane of the y-z axes. However, as explained below, in other example embodiments and modes the non-planar surface irregularities 84 are not linear, and may meander or extend in non-linear fashion, e.g., randomly, e.g., in the plane perpendicular to a plane of the y-z axes

The wrinkling of the embossing results in a z deviation of the non-planar surface features 84 of the embossed facer 112 in contrast to the previously un-embossed facer 110. The facer embossing results in additional or displaced facer material residing in at least some x-z plane cross sections of embossed facer 112. The additional or displaced facer material, indicated by profile/displacement difference 108, results in displacement of some localities of the facer due to the embossing of the facer. The displaced facer material contributes to the non-planar surface features, e.g., the non-planar surface irregularities, in effect increasing the xy surface area over that which is present in a flat facer.

Thus, the embossed facer results from embossing of a previously un-embossed facer 110 whereby the embossing of the un-embossed facer results in a thickness or profile dimensional modification of the embossed facer 112 relative to the un-embossed facer 110. The embossing of the facer may be considered to be a “micro-embossing”. In an example embodiment, the displacement/profile difference 108 for a particular x and y coordinate location may have a measurement Ma, wherein Ma in a range of between 0.0009 inches and 0.0015 inches.

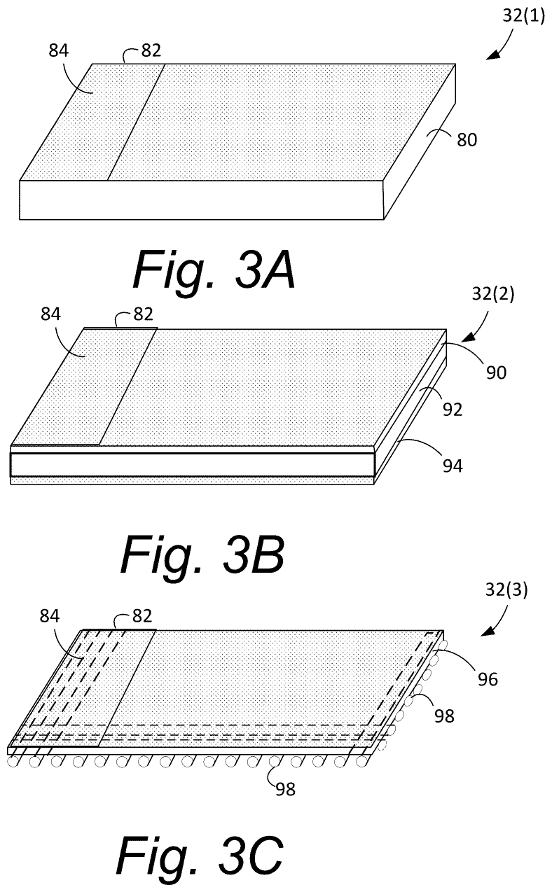

FIG. 3A, FIG. 3B, and FIG. 3C show example, representative, non-limiting embodiments of respective top facers 32(1), facers 32(2), and facers 32(3) which comprise an already embossed facer, e.g., a facer with on-planar surface features e.g., non-planar surface irregularities, in a zone of the facer. As used herein, generic reference to “facer” and/or “top facer 32” may mean any one or more of the example embodiments and modes of facers shown and described with reference to FIG. 3A, FIG. 3B, and FIG. 3C.

FIG. 3A shows an example embodiment and mode in which the facer, e.g., top facer 32(1) and optionally bottom facer 36, comprises a sheet or layer of hard facer material 80, e.g., hard foil. The sheet or layer of FIG. 3A may, in an example, non-limiting embodiment and mode, be a single sheet or single layer. The thickness of the sheet or layer of facer material 80 in the z direction is typically greater than the layers of foils shown in the example embodiments and modes of FIG. 3B and FIG. 3C and is preferably on the order of between 0.00090 inch and 0.0034 inch, and preferably between 0.00090 inch and 0.00060 inch. FIG. 3A further shows a first zone 82 of the sheet or layer of facer material 80, it being understood that other zones exist in the x or machine direction 29 of sheet or layer of facer material 80. As explained previously, the non-planar surface features of each zone, shown in representative fashion by stippling 84, may be generated by one rotation of the top embossing roller 60. The uniformity of the stippling depicting the non-planar surface features 84 is not intended to indicate that the non-planar surface features are necessarily uniform in spacing or z extent within a zone 82, as the non-planar surface features may actually be random both in spacing (in one or more of the x and y direction) and in the z extent. However, the non-planar surface features repeat from zone to zone in view of the embossing pattern of the embossing roller that forms the non-planar surface features. For an example embodiment, the top facer 32(1) of FIG. 3A may be obtained from LLFlex called “ReyFlex Insulation Facer—0.00125″ White Embossed”.

FIG. 3B shows an example embodiment and mode in which the facer, e.g., top facer 32(2), and optionally bottom facer 36, comprises a trilaminate. The trilaminate of top facer 32(2) comprises facer top layer 90, central layer 92, and facer bottom layer 94. The facer top layer 90, which may comprise a foil, for example, is thinner than the sheet or layer of facer material 80 of FIG. 3A. The facer bottom layer 94 may also be a foil layer and may be comparable to the facer top layer 90. Thus, the top facer top facer 32(2) comprises the facer top layer 90; a second layer, e.g., facer bottom layer 94; and a center layer adhered between an inside or back surface of the top layer and an inside surface of the second layer, e.g., central layer 92. In an example implementation, preferably all layers of the trilaminate facer should be embossable, e.g., preferably uniformly and simultaneously embossed. In another example implementation, the facer may comprise some layers that are stretchy and do not require embossing, and other layers that are embossable, e.g., a combination of stretchy and embossable layers. For example, the top and bottom layers of the facer of FIG. 3B could be stretchy like polyethylene and require no emboss, but the center layer may require embossing in order to facilitate imprinting, or any combination of layers that will deform upon imprint “as is” and other layers that require emboss in order to deform. In general, if only the top layer has additional capacity to be deformed by the imprint roller, but the rest of the laminate is flat, there may not be enough depth in the top layer to impart a suitable drainage pattern. Preferably all layers of the facer should provide linear capacity to impart the drainage channel imprint down through and deform the foam core.

In an example embodiment and mode, the thickness of the overall top facer 32(2) is preferably on the order of between 0.0002 inch and 0.0004 inch. The top facer 32(2) is shown in FIG. 3B as also having zones 82 and non-planar surface features 84, at least on the outside or top surface of the facer top layer 90. An outside or bottom surface of the facer bottom layer 94, as well as the central layer 92, may also have non-planar surface features 84.

FIG. 3C shows an example embodiment and mode in which the facer, e.g., top facer 32(3), and optionally bottom facer 36, comprises a bilayer facer. A top layer of the top facer 32(3) comprises a top layer 96. The thickness of the top layer 96 is preferably on the order of between 0.0009 inch and 0.0034 inch, and preferably between 0.0009 inch and 0.0006 inch. Adhered or fixed to a bottom or inside surface of the top layer 96 is a scrim layer 98. That is, the scrim layer is adhered to a foam contact surface of the embossed facer. The scrim layer 98 may comprise scrim elements, such as fibers, e.g., glass fibers, extending uniformly in the x-y directions as shown in FIG. 3C, or fibers arranged in another configuration, or even randomly arranged in the x-y plane. Preferably the scrim layer 98 is non-woven. As described herein, particularly wherein elements of the scrim are random the scrim is configured to contribute to formation of secondary drainage channels. As used herein, to “contribute to formation of a drainage pattern or drainage channel, whether a primary drainage channel or a secondary drainage channel, includes being used either to push or extend the facer into the thermosetting foam mixture, e.g., so as to form a valley, or to enable the thermosetting foam mixture to elevate or enable the facer material to flex, e.g., so as to form a peak. Thus, facer 32(3) comprises the embossed foil, e.g., top foil layer 96, and a scrim, e.g., scrim layer 98, adhered to an inside or back surface of the embossed foil.

The scrim layer 98 of top facer 32(3) may be, for example, either an oriented glass mat or a non-oriented glass mat. In an example embodiment and mode, the scrim layer 98 may weigh 27 pounds per 3000 square feet, and may comprise 20 strands per 100 millimeter in both the machine direction and the cross direction. The top facer 32(3) is shown in FIG. 3C as also having zones 82 and non-planar surface features 84, at least on the outside or top surface of top layer 96. For an example embodiment, the top facer 32(3) of FIG. 3C may be obtained from Lamtec Corporation as Lamtec product FG Mat—0.0015 White Embossed

Other types of facers may be utilized as the top facer 32 (and optionally the bottom facer 36). For example, another type of facer is a trilaminate facer that comprises a top layer of embossed foil, a center layer of a material such as kraft paper, and a bottom layer of a metalized polyethylene terephthalate (PET) film. Another example is a facer which comprises some layers which are stretchy and thus not embossed, but other layers which may be stiff and embossed. As an example implementation, a non-foil facer may incorporate a different layer to impart resistance to gasses escaping the foam and may comprise layers such as polymer films that might stretch.

FIG. 4A-FIG. 4E illustrate localized portions of five different example facers which may be utilized in conjunction with the technology disclosed herein. By illustrating “localized portions”, FIG. 4A-FIG. 4E do not depict an entire facer, but a relatively small sample portion of the facer sufficient to provide an illustration of the orientation of the respective non-planar surface irregularities 84 thereof. The facers which have portions illustrated in FIG. 4A-FIG. 4B utilize essentially linear non-planar surface irregularities 84. The essentially linear nature of the non-planar surface irregularities 84 of the facers of 4A-FIG. 4B is illustrated by the rectangular grid orientation of the non-planar surface irregularities 84, which give the facer an essentially waffle type appearance. The facers which have portions illustrated in FIG. 4C-FIG. 4E utilize essentially non-linear non-planar surface irregularities 84. The non-linear non-planar surface irregularities 84 are illustrated by the non-linear geometric features of FIG. 4C-FIG. 4E. The facer of FIG. 4E is of the type of FIG. 3C, e.g., comprises a scrim with non-linear scrim elements.

Tests were performed to determine the variability of the embossed surface area compared to flat surface area of a pre-embossed facer. The test results are shown in Table 1 below. Table 1 shows that the surface area difference for the facers of FIG. 4A-FIG. 4B that utilize essentially linear non-planar surface irregularities 84 ranged from 2.24% to 8.37%, whereas the surface area difference for the facers of FIG. 4C-FIG. 4E that utilize essentially linear non-planar surface irregularities 84, e.g., random non-planar surface irregularities 84, ranged from 1.00% to 22.70%.

TABLE 1

| | | | Difference |
|---|---|---|---|
| | | | between |
| | | | Embossed |
| | Embossed | | Surface |
| | Surface | | Area Measured |
| | Area | Calculated Flat | and Flat |
| Sample | Measured | Surface Area | Surface Area |
| FIG. 4A: French | 31.188 × 106 μm² | 30.504 × 106 μm² | 2.24% |
| Silk (Butter) #1 | | | |
| FIG. 4B: French | 38.033 × 106 μm² | 34.848 × 106 μm² | 8.37% |
| Silk (Butter) #2 | | | |
| FIG. 4C: Random | 30.803 × 106 μm² | 30.498 × 106 μm² | 1.00% |
| FIG. 4D: Random | 37.786 × 106 μm² | 27.285 × 106 μm² | 22.70% |

A discovery of the technology disclosed herein is that wrinkling of the embossed top facer 32 provides facer material, e.g., previously or pre-displaced facer material, for the formation of the non-planar surface features 84. As used herein, “displaced” or “pre-displaced” refers to the relative relocation of at least some localities of facer material of the previously un-embossed facer 110 to the configuration of the embossed facer 112 with its non-planar surface features due to the wrinkling caused by the facer embossing, before entry into the imprinting process of laminator assembly 20. The non-planar surface features 84 in turn provide the displaced or wrinkled facer material that facilitate the imprinting by top imprinting roller 60, e.g., extra dimensional capacity, e.g., linear capacity, of facer material for molding of the facer, e.g., into the primary drainage pattern 66. Table 1 thus describes surface area difference, but may also characterize how a uniform thickness facer is pre-deformed up and down so that a pattern may be imprinted, and may also characterize how the facer has been compressed in thickness some areas, e.g., thus “longer” in x-y planes, and not in other areas, so that the “longer, thinned” areas may be used to impart the imprinted pattern. In a sense, Table 1 reflects an adding up all the peaks and valleys on the surface, however formed, in comparison to a facer where it is flat, the difference being the added linear capacity that has been imparted.

The non-planar surface irregularities 84 of the facer, e.g., the pre-displaced localities of the facer material, may result from various facer production techniques. For example, the non-planar surface irregularities 84 of the facer may result from the from the facer material being pressed or smashed into portions of differing material thicknesses. As another example, non-planar surface irregularities 84 of the facer may result from the from an embossing process in which an embossed pattern is initiated in a middle or central portion of the facer and is progressively extended to the edges of the facer, with a result that a dimension of the facer other than its thickness changes during the embossing process. Without the wrinkled or displaced facer material that becomes available by virtue of the embossment of the top facer 32 before the top facer 32 enters the laminator assembly 20, the faced thermosetting foam composite 50 and the insulation board 70 may not receive the primary drainage pattern 66, e.g., the foil on the top facer 32 may break or tear.

The micro-embossing may, at least in some example embodiments and modes, appear generally as wrinkles of equal depth and distribution across the entire product surface. In yet other and presently preferred embodiments, such as illustrated in and described with reference to FIG. 4C and FIG. 4E, the wrinkles appear as a random pattern with variation of depth and distribution. The wrinkles provides extra facer material in three dimensions across the surface that is used to form into three dimensions against the imprinted foam. The material is stored in the facer by micro embossing so that extra facer material in the form of wrinkles is spread, preferably randomly, across the entire surface. The extra material is used in the pressure stage of the imprinting process to take on the 3-dimensional shape that the imprinting pattern dictates and imparts into the foam board.

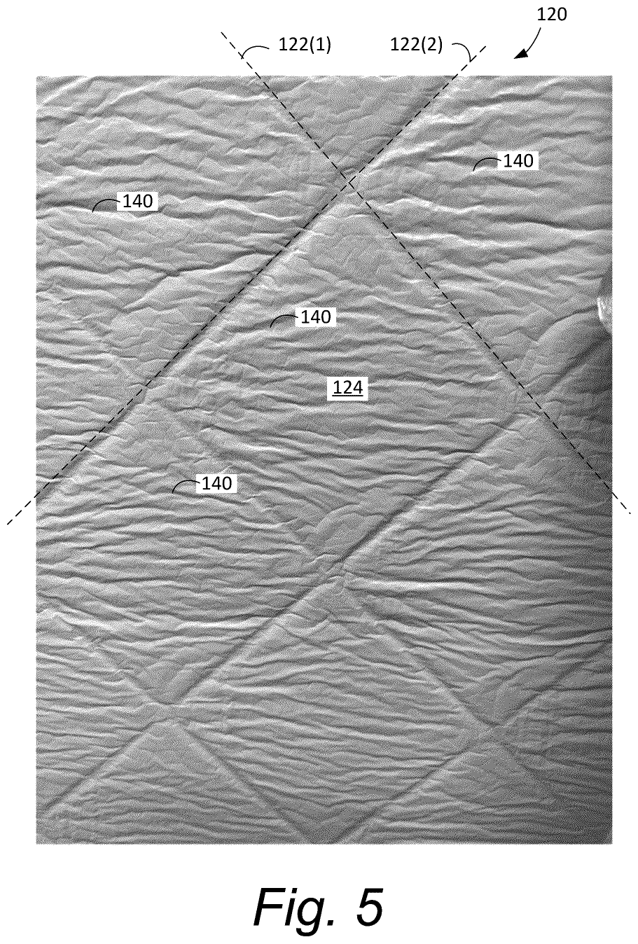

As indicated above, before the thermosetting foam composite 50 is cured, in imprinting section 26 a primary drainage pattern 66 is imprinted on a front surface of the thermosetting foam composite 50. The primary drainage pattern 66 is imparted to faced thermosetting foam composite 50, e.g., to the outside surface of top facer 32, by the imprinting pattern of the top imprinting roller 60. FIG. 5 shows from above, e.g., looking down from the z direction, an enlarged segment of an example insulation board 70 in which an example primary drainage pattern 66 is illustrated. The primary drainage pattern 66 of FIG. 5 is essentially a diamond-shaped pattern 120 comprising plural primary drainage channels 122(1) and 122(2). The primary drainage channels 122(1) are shown in FIG. 5 as generally extending from a top left edge of the sheet of FIG. 5 toward a bottom right edge, whereas the primary drainage channels 122(2) are shown in FIG. 5 as generally extending from a top right edge of the sheet of FIG. 5 toward a bottom left edge. Thus the primary drainage channels 122(1) and primary drainage channels 122(2) criss cross each other to form the diamond-shaped primary drainage pattern 66. The diamond-shaped primary drainage pattern 66 results in the formation or definition of surface islands 124 between the primary drainage channels 122. In view of the diamond-shaped primary drainage pattern 66 of FIG. 5, the surface islands 124 themselves have essentially a diamond shape on the front surface of the building sheathing 70.

The spacing, widths, and depths of the primary drainage channels 122 depend on the imprinting pattern of the top imprinting roller 60. As written in prior sections, the extra linear capacity of the embossed facer is key to allowing the imprint to extend down into the foam core, the depth of which is now limited only by the linear capacity of the embossed facer. Without the microembossing, a facer would have essentially zero extra linear capacity and would present tensile forces which resist imprinting, providing little to no depth of imprinting and/or leading to the facer tearing and thus losing functionality of a water or air resisting layer on the foam board. The microembossing of the facer which results in the non-planar surface features 84 provides the extra linear capacity of the embossed facer and thereby allows the imprint to extend down into the foam core to fully form the drainage pattern(s), such as primary drainage channels 60.

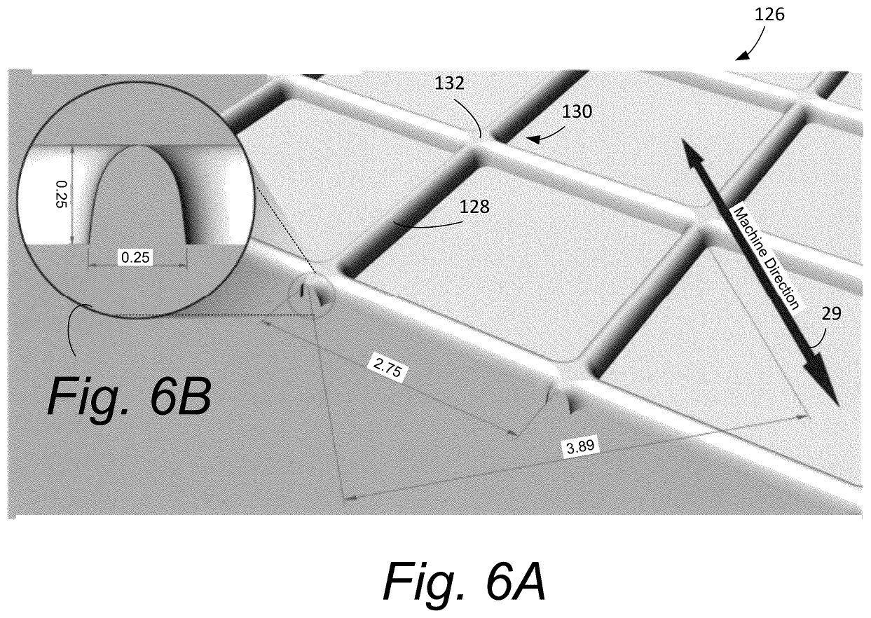

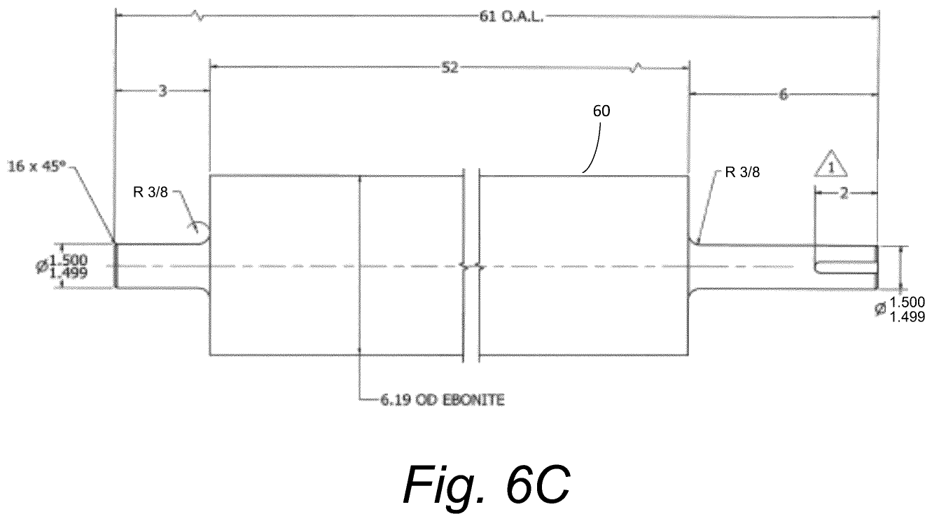

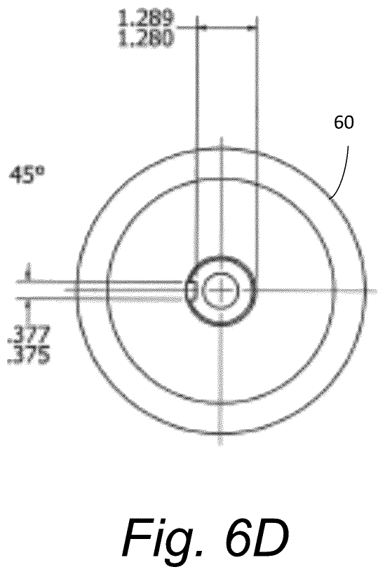

The imprinting pattern of the top imprinting roller 60 results from attachment to or formation of an imprinting grid or mat 126 on the top imprinting roller 60. FIG. 6A shows an enlarged section of a portion of an example imprinting grid 126 for an example top imprinting roller 60. The imprinting grid 126 comprises crisscrossed grid projections 128 which have an essentially inverted “U” shape, with the rounded pinnacle of the “U” being oriented to press into the yet uncured faced thermosetting foam composite 50 in order to form the primary drainage channels 122. The grid projections 128 crisscross at grid nodes 130. At the grid nodes 130, the inverted “U” shaped grid projections 128 intersect to form an essentially flat or radiused intersection surface 132. The flat or radiused intersection surfaces 132 advantageously avoid “star” patterns formations and thereby avoid creating “dams” in the channels.

As described below, the configuration of the inverted “U” shaped grid projections 128 and the configuration of the essentially flat intersection surfaces 132 are chosen in view of the imprintment of the outside surface of top facer 32. The configurations are particularly chosen so that the intersections of the grid projections 128 are not too sharp, e.g., are chosen to be radiused to avoid large creases.

FIG. 6B shows an enlarged section of a portion of an example grid projection 128 for the embossing grid 126 of FIG. 6A. In an example embodiment and mode shown in FIG. 6B, the extent of the grid projection 128 in the z direction, and thus the depth of the resultant primary drainage channels 122 in the z direction, is in a range of from and including 1/16 inch to and including ¼ inch, with ⅛ inch being preferred. The width of the grid projection 128 in the x-y plane, and thus the width of the resultant primary drainage channels 122, is in a range of from and including 1/16 inch to and including ¼ inch, with ⅛ inch being preferred.

FIG. 6A shows that, in an example, non-limiting embodiment and mode, the extent of spacing or separation between parallel adjacent grid projections 128 is 2.75 inch, plus or minus 0.25 inch. FIG. 6A further shows that, in an example, non-limiting embodiment and mode, the extent of spacing or separation between grid nodes 130 in the machine direction 29 is 3.89 inch, plus or minus 0.25 inch. It should be understood, however, that the spacing may vary in other example embodiments and modes, and that the spacing or separation between parallel adjacent grid projections 128 could vary from 12 inches×12 inches to ½ inch×½ inch, for example. Moreover, the pattern need not be square, e.g., a different number of lines may be provided for different directions, and the lines need not necessarily be straight but could be curved or squiggle, for example.

FIG. 6C is a right side view of the example top imprinting roller 60 of FIG. 1, e.g., looking from the right of FIG. 1 in the −x direction, and showing structure of top imprinting roller 60 for mounting to an unillustrated frame of laminator assembly 20. FIG. 6D is a front view of an end of the example top imprinting roller 60 of FIG. 6C.

Although not illustrated, a shaft of the top imprinting roller 60 may be coupled to a selectable speed electric motor that drives the rotation of the top imprinting roller 60 by a keyway. The coupling of the shaft of top the imprinting roller 60 to the selectable speed motor enables the top imprinting roller 60 to be rotated at a revolution speed that is appropriate for the line speed of the laminator assembly 20.

It should be appreciated that a primary drainage pattern other than a diamond-shaped primary drainage pattern may be imparted to the faced thermosetting foam composite 50, and thus to insulation board 70, depending on the imprinting pattern of the top imprinting roller 60. Similarly, the spacing, widths, and depths of the primary drainage channels may be modified depending on the imprinting pattern of the top imprinting roller 60.

As explained above, the wrinkling of the embossed foil of the top facer 32, before entry into laminator assembly 20, displaces foil material of the faced thermosetting foam composite 50, and provides pre-displaced foil material for the formation of the non-planar surface features. The non-planar surface features 84 in turn provide foil material that facilitate the imprinting by top imprinting roller 60, e.g., extra linear capacity of foil for molding of the foil into the primary drainage pattern 66.

In addition, the wrinkling of the embossed foil of the top facer 32, before entry into laminator assembly 20, provides secondary drainage channels 140 on at least some of the surface islands 124 of the insulation board 70. Unlike the primary drainage channels 122, which have an established pattern according to the pattern of the top imprinting roller 60, the secondary drainage channels 140 are less uniform. The secondary drainage channels 140 result from the embossing pattern of the foil of the top facer 32 before the top facer 32 enters the laminator assembly 20, as well as interaction of the top facer 32 with the pressures and forces applied on top facer 32 by top imprinting roller 60. In an example embodiment and mode, the secondary drainage channels 140 may serve to drain moisture from the surface islands 124 to the primary drainage channels 122.

As mentioned above, FIG. 3C depicts an embossed facer layer adhered to a scrim 98, preferably a non-woven scrim. FIG. 4C and FIG. 4D depict example embodiments and modes of embossed facers which are randomly embossed, e.g., comprise a randomly embossed foil. FIG. 4E depicts an example embodiment and mode of a facer that comprises a scrim which in turn comprises randomly oriented scrim elements, e.g., scrim fibers. Thus, the facer of FIG. 4E comprises a random direction non-woven scrim. A “random direction non-woven scrim” is a scrim in which the scrim fibers are randomly arranged in at least one direction. For example, the scrim fibers may comprise a spaghetti-like layer of scrim fibers.

The facers hereof, including the facers of the FIG. 3C, FIG. 4C, FIG. 4D, and FIG. 4E have an embossed surface to provide additional linear capacity so that drainage channels may be imparted to the foam board, allowing a primary drainage pattern 66 to be imprinted on a front surface of the thermosetting foam composite 50 as described above. The primary drainage pattern 66 is imparted to faced thermosetting foam composite 50, e.g., to the outside surface of top facer 32, by the imprinting pattern of the top imprinting roller 60. In the example embodiment and mode such as that of FIG. 4E, the nonwoven scrim under the embossed facer layer reacts with zones of resistance to the pressures and forces imparted by the imprinting roller interspersed with random zones of no resistance. For example, the locations and presence of the random direction fibers of the scrim layer 98 reacts with zones of resistance to the pressures and forces imparted by the imprinting roller interspersed with random zones of no resistance. The resulting micro wrinkles are thus also imparted to the otherwise largely flat islands formed between the intersecting primary drainage channels 122, providing the array of secondary drainage channels 140 progressing across the majority of outside top facer 32 as shown, by way of example, in FIG. 5. In this manner, the secondary drainage channels 140 increase the functional drainage capacity of outside top facer 32. While the secondary drainage channels 140 are shallower than the primary drainage channels 122, there are many more secondary drainage channels 140 than primary drainage channels 122. Depending on how far the primary drainage channels 122 are spaced apart and thus how large or small the flat islands are, incorporating the secondary drainage channels 140 into these non-channel imprinted areas of the foam board composite can increase the drainage capacity from 25% to as high as 300%.

Thus, the technology disclosed herein concerns a building sheathing, such as insulation board 70, which comprises a foam core; an embossed facer, and a second facer. The embossed facer is adhered to a first surface of the foam core. The foam core results from a foam mixture 44 that is cured between the embossed facer and the second facer. The embossed facer comprises non-planar surface features on an outside surface of the embossed facer. The second facer is adhered to a second surface of the foam core. A primary drainage pattern is provided on a first surface of the building sheathing and extends into the embossed facer and the foam core. The primary drainage pattern comprises plural primary drainage channels which define islands on the first surface of the building sheathing. The non-planar surface features on the front surface of the embossed facer provide secondary drainage channels on at least some of the islands. In an some example embodiments and modes, such as in an example embodiment and mode in which an embossed facer with or comprising an underlying non-woven scrim on the foam core, secondary drainage channels are provided on a surface area of the islands.

In an example embodiment and mode, the plural primary drainage channels extend to a depth of between 1.5% and 25% of the thickness of the thermosetting foam composite. On the other hand, the plural secondary drainage channels extend to a depth of between 0.4% and 6% of the thickness of the thermosetting foam composite. In an example embodiment and mode, the depth of the secondary drainage channels 140 is preferably on the order of between 1/64″. Thus, the secondary drainage channels 140 may be referred to as “microchannels”.

The insulation board 70 is typically installed on a building with a vertical orientation and then covered with cladding. The insulation board 70 may be installed either with the primary drainage pattern 66 formed on the surface of insulation board 70 overlaid by the cladding, or conversely with the primary drainage pattern 66 facing the wall or structure that is covered by the insulation board 70. In either orientation, the primary drainage pattern 66 facilitates drainage by gravity of moisture trapped between insulation board 70 and the adjacent surface (e.g., either the cladding or the wall) down through the primary drainage channels 122 to the foundation or base of the building where it exits the wall. Further, the secondary drainage channels 140 provide additional drainage capability, e.g., draining moisture from the surface islands 124 to the primary drainage channels 122. The primary drainage pattern 66 and the secondary drainage channels 140 not only facilitate drainage but also allow for a control of drainage. In some installations and situations in which the moisture may not be able to immediately drain by gravity via the primary drainage pattern 66 due to a blockage, the secondary drainage channels 140 provide alternate pathways so that the moisture can eventually be discharged via an adjoining non-blocked primary channel. As understood by those in the building science industry, the air shared in the wall by the primary and secondary channels facilitates both moisture vapor transfer laterally within the wall and buffering of any moist areas of the space between the adjacent materials to the dry areas. Such movement of moist air and buffering within the wall that is dependent on the primary and secondary channels is termed hygric redistribution. In this way the channels facilitate both drainage of bulk water down the wall and adjoining layer, and the lateral movement of moist air in the wall planar x-y directions from wetter to dryer zones independent of bulk water drainage.

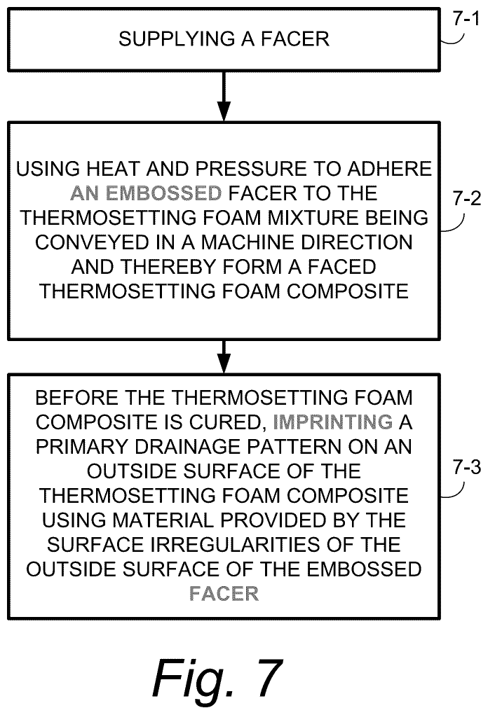

FIG. 7 is a flowchart showing basic, representative acts or steps comprising a process of making a sheathing or insulation board of the technology disclosed herein, such as insulation board 70. Act 7-1 comprises supplying a facer comprising an outside surface, the outside surface of the facer comprising an embossed facer. For example, Act 7-1 may comprise feeding a facer, such as top facer 32, into a laminator. As explained herein, the facer comprises 32 an outside surface comprising an embossed facer. The embossed facer comprises non-planar surface features 84 on the outside surface of the facer in a thickness dimension of the facer.

Act 7-2 comprises using heat and pressure to adhere the facer to the thermosetting foam mixture being conveyed in a machine direction and thereby form a faced thermosetting foam composite. For example, the faced thermosetting foam composite 50 may be formed by depositing or applying the foam mixture 44 to an inside surface of bottom facer 36 so that the foam mixture 44 experiences heat and pressure, e.g., internal pressure of the expanding foam mixture 44 against the pressure/constraint of the platens, to adhere an inside surface of the top facer 32 to the thermosetting foam mixture 44 being conveyed in a machine direction. The foam mixture 44 is also adhered to the inside surface of the bottom facer 36. Act 7-2 is preferably performed in a laminator.

Act 7-3 comprises, before the thermosetting foam composite is cured, imprinting a primary drainage pattern 66 on an outside surface of the thermosetting foam composite using, at least in part, embossed material provided by the non-planar surface features of the outside surface of the embossed facer. As the foam mixture 44 hardens or cures, it becomes the core of the insulation board 70.

The imprinting of act 7-3 may also comprise or encompass, in addition to the formation of the primary drainage pattern 66, the formation of secondary drainage channels 140, particularly when the facer utilized is a facer that includes a scrim, such as the facers having randomly oriented scrim elements, e.g., randomly oriented fibers, such as the facer of FIG. 4E, for example.

In a non-limiting example embodiment and mode, a bottom facer 36 may also be laminated to form the faced thermosetting foam composite 50. An outside surface of the bottom facer 36 may also have an embossed facer.

In a non-limiting embodiment and mode, an embossed top facer may be adhered to a fully cured foam core such as expanded polystyrene and imprinted with primary drainage channels by an imprinting roll and pressure which exceeds the elastic limit (permanent denting pressure) of the foam core.

Although the description above contains many specificities, these should not be construed as limiting the scope of the technology disclosed herein but as merely providing illustrations of some of the presently preferred embodiments of the technology disclosed herein. Thus, the scope of the technology disclosed herein should be determined by the appended example embodiments and their legal equivalents. Additionally, it is intended that such equivalents include both currently known equivalents as well as equivalents developed in the future, i.e., any elements developed that perform the same function, regardless of structure. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. A building sheathing, comprising:
a foam core;
an embossed facer adhered to a first surface of the foam core, the embossed facer comprising non-planar surface features on an outside surface of the embossed facer;
a primary drainage pattern provided on a first surface of the building sheathing and extending into the embossed facer and the foam core, the primary drainage pattern comprising plural primary drainage channels which define islands on the first surface of the building sheathing.

2. The sheathing of claim 1, wherein the embossed facer results from embossing of a previously un-embossed facer whereby the embossing of the un-embossed facer results in an increased surface area of the embossed facer relative to the un-embossed facer, and wherein the increased surface area is in a range of between 1.00% and 22.70% of the surface area of the un-embossed facer.

3. The sheathing of claim 1, wherein the embossed facer results from embossing of a previously un-embossed facer whereby the embossing of the un-embossed facer results in a thickness profile displacement of the embossed facer relative to the un-embossed facer and wherein the thickness profile displacement is in a range of between 0.0009 inches and 0.0034 inches.

4. The sheathing of claim 1, further comprising secondary drainage channels provided on at least some of the islands by facer material of the non-planar surface features on the first surface of the embossed facer.

5. The sheathing of claim 4, wherein the embossed facer further comprises a scrim on a surface of the embossed facer, and wherein elements of the scrim are configured to contribute to formation of the secondary drainage channels.

6. The sheathing of claim 5, wherein the scrim comprises non-woven elements which are randomly oriented.

7. The sheathing of claim 1, further comprising a second facer adhered to a second surface of the foam core.

8. The sheathing of claim 1, wherein the plural primary drainage channels define islands having essentially a diamond shape on the first surface of the building sheathing.

9. The sheathing of claim 1, wherein the plural primary drainage channels extend to a depth of between 1.5% and 25% of the thickness of the building sheathing, and wherein the plural secondary drainage channels extend to a depth of between 0.4% and 6% of the thickness of the building sheathing.

10. The sheathing of claim 1, wherein the plural primary drainage channels extend to a depth of between one sixteenth inch and one quarter inch into the thickness of the building sheathing, and wherein the plural secondary drainage channels extend to a depth of between one sixty fourth inch and one sixteenth inch into the thickness of the building sheathing.

11. The sheathing of claim 1, wherein the embossed facer is embossed foil.

12. A building sheathing, comprising:
a foam core;
an embossed facer adhered to a first surface of the foam core, the embossed facer comprising:
an embossed outer layer comprising non-planar surface features on an outside surface of the embossed facer;
a scrim layer on a surface of the embossed outer layer, the scrim layer comprising scrim elements which are at least partially randomly oriented;
a primary drainage pattern provided on a first surface of the building sheathing and extending into the embossed facer and the foam core, the primary drainage pattern comprising plural primary drainage channels which define islands on the first surface of the building sheathing, and
secondary drainage channels provided on at least some of the islands;
wherein the scrim elements are configured to contribute to formation of the secondary drainage channels.

13. The sheathing of claim 12, wherein the facer material of the non-planar surface features on the first surface of the embossed facer is configured to contribute to formation of the secondary drainage channels.

14. The sheathing of claim 12, wherein the embossed facer results from embossing of a previously un-embossed facer whereby the embossing of the un-embossed facer results in a thickness profile displacement of the embossed facer relative to the un-embossed facer and wherein the thickness profile displacement is in a range of between 0.0009 inches and 0.0034 inches.

15. The sheathing of claim 12, wherein the scrim comprises non-woven fibers.

16. A process of making a building sheathing, comprising:
supplying a facer comprising an outside embossed facer layer, the outside embossed facer layer comprising non-planar surface features in a thickness dimension of the facer;
using heat and pressure to adhere the facer to the thermosetting foam mixture being conveyed in a machine direction and thereby form a faced thermosetting foam composite;
before the thermosetting foam composite is cured, embossing a primary drainage pattern on a surface of the thermosetting foam composite using at least in part facer material provided by the non-planar surface features of the outside embossed facer layer.

17. The process of claim 16, further comprising impressing at least some of the facer material of the non-planar surface features on the first surface of the embossed facer into the thermosetting foam mixture to at least partially form the primary drainage pattern.

18. The process of claim 16, wherein the facer further comprises a scrim on a surface of the outside embossed facer layer, and wherein elements of the scrim are configured to contribute to formation of secondary drainage channels.

19. The sheathing of claim 18, wherein the scrim comprises non-woven elements which are randomly oriented.

20. A building sheathing made by the process of claim 16.
